(19) United States
(12) Patent Application Publication
(10) Pub. No.: US 2024/0029121 A1
(43) Pub. Date: Jan. 25, 2024

(54) METHODS AND APPARATUSES FOR IMPULSE PURCHASES AT REMOTE LOCATIONS

(71) Applicant: Bell and Howell, LLC, Durham, NC (US)

(72) Inventors: James Hermanowski, Wake Forest, NC (US); Mark Gerard Paul, Raleigh, NC (US)

(21) Appl. No.: 18/354,874

(22) Filed: Jul. 19, 2023

Related U.S. Application Data
(60) Provisional application No. 63/390,703, filed on Jul. 20, 2022.

(51) Int. Cl. G06Q 30/02; G06Q 30/0601; G06Q 10/0836

(52) U.S. Cl. CPC G06Q 30/0281; G06Q 30/0631; G06Q 10/0836

(57) ABSTRACT

An automated order pickup system enabling impulse purchases of impulse purchase items during order pickup by a customer includes a housing; a plurality of order storage bins within the housing; a display; and a user terminal. The system receives orders that have been purchased or are designated for purchase by the customer. Each of the orders is assigned to at least one of the plurality of order storage bins. A unique customer credential is authenticated to identify the customer's order. Promotional information for one or more of the impulse purchase items is selected, preferably, based on the items in the customer's order or order history. The order pickup system dispenses any selected impulse purchase items to the customer, as well as the one or more items in the order to be received by the customer. The promotional information is displayed to the customer on the display.

### CROSS-REFERENCE TO RELATED APPLICATIONS

This application claims priority to U.S. Provisional Patent Application No. 63/390,703, which was filed on Jul. 20, 2022, the contents of which are incorporated by reference herein in the entirety.

### BACKGROUND

The desirability for retailers to encourage impulse purchases by consumers is well-known. Conventional impulse purchase systems and methods typically are implemented and/or performed at or adjacent to the location within the retail location where payment is made for the goods and/or services being purchased by the consumer, this location is often commonly referred to as the “checkout lane”. Such payment locations have traditionally been almost exclusively located at a fixed location within a physical brick-and-mortar store. When such conventional impulse purchase systems and methods are utilized, the merchant (commonly referred to as a “retailer”) creates a situation in the checkout lane with the goal of predisposing a customer (commonly referred to as a “consumer”) towards feeling a need to acquire one or more goods and/or services, which can be satisfied by an immediate purchase and receipt of such goods and/or services being offered as an “impulse” purchase. The goal of this scenario presented by the retailer is a reinforcing instant gratification for the consumer.

Alternatives exist in both digital and physical forms that attempt to drive additional consumer purchases, examples of which can include coupons, promotions, and the like. However, these known approaches fail to produce the same feeling in a consumer of needing to purchase the goods and/or services due to a lack of the instant gratification from such purchases achieved by such known alternatives, unlike the instant gratification provided by the impulse purchases provided when conventional impulse purchase systems and methods are utilized. This lack of instant gratification in such known alternatives is caused because there is a spatial and/or temporal separation between the time and/or place where the action (e.g., impulse purchase) is performed and the time and/or place where the goods and/or services are received by the customer. For example, an e-commerce platform may, during an online checkout sequence, offer for purchase one or more goods and/or services that are complementary to goods and/or services already being purchased by the user. However, in this instance, even if the consumer is purchasing the goods and/or services for pickup or delivery later that same day, the fact remains that the consumer will not instantly receive the complementary goods and/or services upon completion of the transaction, but must instead wait until at least some time later that same day, if not one or more days in the future, to receive such complementary goods and/or services, thereby failing to provide the feeling of instant gratification provided when conventional impulse purchase systems and methods are utilized.

E-commerce purchasing methods continue to proliferate globally, accounting for approximately 20% or more of sales. The growth of e-commerce, especially during the COVID-19 pandemic, was impacted by quarantine and illness of the labor necessary to satisfy orders. The growth of e-commerce has continued unabated as the severity of the restrictions imposed during COVID-19 pandemic has waned. Methods to keep operations running and reduce costs through automation of the warehouse and fulfillment operations have thus grown substantially to address the higher throughput required with limited labor availability.

The consumer-facing processes of e-commerce, such as, for example, order pickup and delivery, have remained labor intensive until very recently. Technological advancements in automation, including automated pickup and/or delivery units, have been made in recent years to automate order delivery to the customer and/or the delivery agent (e.g., a person tasked with delivering the order to a location specified by the customer). These new automation technologies have allowed an exceptionally high level of end-to-end mechanization and cost reduction for many e-commerce processes.

Many retailers, especially grocery stores, and their vendors depend on the consumer being physically present in the retail location (e.g., store) to drive additional business, such as impulse purchases. Stores have specifically designed checkout lanes and mechanisms to entice consumers to add last-minute, or impulse, purchases during the checkout process. The items typically presented to the customer for such impulse purchases are commonly items that have a much higher profit margin than the average profit margin of all of the items in the store and, accordingly, represent a significant and lucrative revenue stream and profit source for both the retailer and the vendor of such items. However, the proliferation of e-commerce transactions has effectively isolated the customer from the retailer's conventional impulse purchase mechanisms and, as a direct consequence thereof, also negatively impacted sales of these highly profitable impulse purchase items.

In the process of purchasing physical goods online there is, almost by definition, a physical and temporal separation between the customer, the goods, and the retailer supplying the goods. The customer, often at home, selects specific items to purchase from a specific retailer, often by proactively searching for the specific items of interest to the customer on the retailer's website and/or mobile application, by adding the specific items to the customer's virtual shopping cart. While it is now commonplace for a retailer to suggest products to a customer based on, for example, items already in the customer's virtual shopping cart, shopping history, and/or a prearranged promotion campaign with a vendor, the fact remains that the instant gratification of the customer receiving these items immediately upon checkout is missing in such offerings and, therefore, customers are more resistant to making such purchases in the absence of the previously enabled instant gratification known from conventional impulse purchase mechanisms. After an e-commerce order is submitted to a retailer by a customer, the retailer requires time to collect together all of the items ordered by the customer and to prepare the order for receipt by the consumer. The hand-off (e.g., delivery) to the consumer may occur at a physical store, at a secure pickup unit or locker, via delivery to the home, or via shipment to a location designated by the customer. There is no physical checkout lane for e-commerce purchases, the point of sale is virtual. Currently known digital impulse purchase mechanisms are limited to being presented to the customer at the time of order submission, such as, for example, presenting advertisements and/or coupons to a customer during the e-commerce order submission process. Due to the temporal and spatial separation of the customer from the goods and retailer in an e-commerce transaction, currently known digital impulse purchase mechanisms inherently do not deliver the type of instant gratification to the customer provided in the conventional impulse purchase mechanisms traditionally found in the checkout lane of a retailer.

Thus, a presently unmet need exists, in which systems and methods are used, especially systems and methods that use automation, to enable impulse purchases at a location that is remote from (e.g., not physically adjacent to, or collocated with) a physical checkout lane and, even more specifically, impulse purchase capability at a point near the time and/or place where the customer receives the goods and/or services.

### SUMMARY

Disclosed herein are systems and methods that enable spontaneous, “last-minute,” and impulse purchases of goods and/or services at or adjacent to one or more locations within a retail environment (e.g., a physical brick-and-mortar store) that are remote from a conventional checkout lane. According to one example, such a location may be a location to which a user is directed for receipt of goods and/or services previously requested (e.g., ordered, such as via the Internet), such as at an order pickup location that is remote from a store (e.g., physically spaced apart from a store, such as being in another structure that is separate from the store, in a parking lot of the store, etc.). According to the systems and methods disclosed herein, the customer may be presented with an offer to select one or more goods and/or services not already included in the customer's order being picked up or, for example, the customer may be presented with a reminder to add often-needed goods and/or services to the customer's order. The goods and/or services selected by the customer are then automatically provided to the customer as a part of the customer's previously submitted order, thereby recreating the type of instant gratification for the customer that has heretofore only been able to be provided in the checkout lane of a traditional retail store.

### BRIEF DESCRIPTION OF THE DRAWINGS

FIG. 1 is a schematic illustration of a conventional retail checkout lane with impulse purchase capability.

FIG. 2 is a schematic illustration of an example embodiment of a system for enabling impulse purchase at a location separate from a conventional retail checkout lane at a retail store.

FIG. 3 is a schematic illustration of an example embodiment of an automated order retrieval station.

FIG. 4 is a schematic illustration of an example embodiment of another automated order retrieval station having impulse purchase capability.

FIG. 5 is a schematic illustration of a system comprising a plurality of the automated order retrieval stations shown in FIG. 4.

FIG. 6 is a schematic illustration of a system comprising a plurality of the automated pickup systems shown in FIG. 5.

### DETAILED DESCRIPTION

The subject matter disclosed herein addresses problems encountered due to the heretofore inability of a retailer to offer to a customer, who is retrieving an order (e.g., comprising one or more items) at a remote order retrieval terminal, the opportunity to make impulse purchases of one or more items, which can be related to any of the items in the customer's order or unrelated to any of the items in the customer's order.

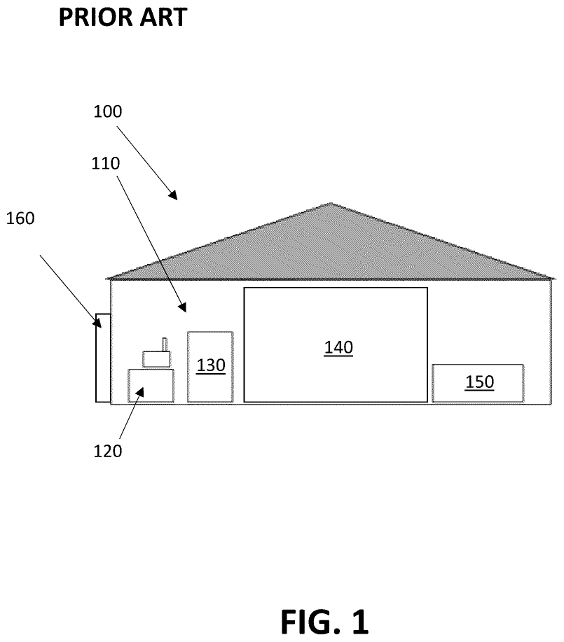

As shown in FIG. 1, an example embodiment for the arrangement of a retail store, generally designated 100, known from the prior art is schematically illustrated therein. The retail store 100 has a main retail assortment 140 that is located a distance away from (e.g., so as to not be adjacent to) the retail store entrance, generally designated 160, to which the checkout lane area, generally designated 110, is adjacent. The checkout lane area 110 is positioned within the retail store 100 such that customers are directed to pass through the checkout lane area 110 when purchasing items (e.g., goods and/or services) at the point of sale, generally designated 120, (e.g., a cash register or other commercial transaction terminal). As the customers are being directed to pass through the checkout lane area 110, such customers are traditionally exposed to impulse purchase area 130, which contains impulse purchase items and/or signage to encourage customers to make impulse purchases of specific items displayed to the consumers in the impulse purchase area 130. Additionally, as shown in FIG. 1, the retail store 100 also comprises a customer service desk 150, which is located apart from (e.g., in a different section of the retail store 100, not adjacent to) the area of the retail store 100 in which the checkout lane area 110 is located.

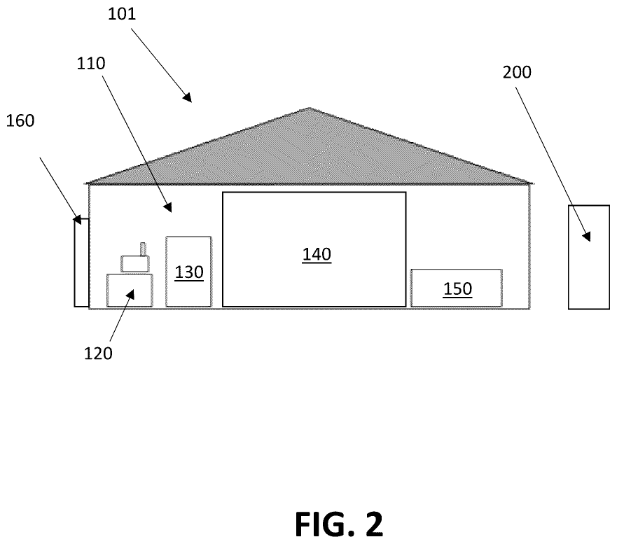

FIG. 2 shows an example embodiment of a retail store, generally designated 101, and an automated pickup system, generally designated 200. The retail store 101 has a main retail assortment 140 that is located a distance away from (e.g., so as to not be adjacent to) the retail store entrance, generally designated 160, to which the checkout lane area, generally designated 110, is adjacent. The checkout lane area 110 can comprise, for example, one or more (e.g., a plurality of) lines or queues in which customers wait until it is the customer's turn to proceed to the point of sale, generally designated 120, (e.g., a cash register or other commercial transaction terminal) to submit payment for the goods and/or services being purchased from the retailer. The checkout lane area 110 is thus positioned within the retail store 101 such that customers are directed to pass through the checkout lane area 110 when purchasing items (e.g., goods and/or services) at the point of sale 120 (e.g., a cash register). As the customers are being directed to pass through the checkout lane area 110, such customers are traditionally exposed to an impulse purchase area 130, which contains impulse purchase items and/or signage to encourage customers to make impulse purchases of specific items displayed to the consumers in the impulse purchase area 130. Additionally, as shown in FIG. 2, the retail store 101 also comprises a customer service desk 150, which is located apart (e.g., in a different section of the retail store 100) from the area of the retail store 100 in which the checkout lane area 110 is located.

The automated pickup system 200 is, as shown in FIG. 2, located separate from (e.g., physically segregated from, such as external to the retail store 100) the checkout lane area 110, the point of sale 120, and the impulse purchase area 130. The automated pickup system 200 can be, for example and without limitation, physically attached to the retail store 101, in which case the automated pickup system 200 is accessible to customers from inside and/or outside the retail store 101. In some embodiments, the automated pickup system 200 can be operated as a standalone structure, such as a kiosk, that can be deployed either inside or outside of the retail store 101. In a preferred embodiment, the automated pickup system 200 is in a location that is easy for customers to access. Thus, the automated pickup system 200 can be located, in various embodiments, outside the retail store 101, in a parking lot near the retail store 101, or even miles away from the retail store 101, such as in a location that is convenient to a designated community of customers of the retail store 101.

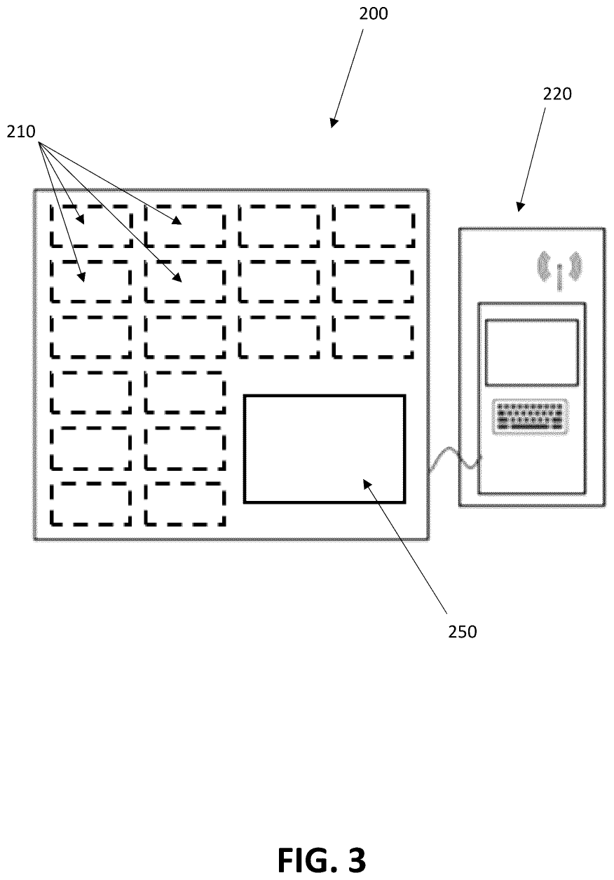

FIG. 3 shows an example embodiment of an automated pickup system, generally designated 200, which is designed to hold customer orders awaiting pickup or retrieval by the customer in one or more order storage bins, generally designated 210, which are internal to the automated pickup system 200. The automated pickup system 200 can thus be in the form of a housing that has a plurality of individually accessible lockers (e.g., order storage bins 210) provided therein that are accessible from outside of the housing to allow retrieval of items ordered by a customer from one or more of the individually accessible lockers. In the example embodiment shown, the order storage bins 210 are not directly accessible by a user from outside of the housing but are instead only accessible via a transfer mechanism (e.g., a series of conveyors, elevators, cranes, etc.) that is used for inputting items into a designated one of the order storage bins and/or retrieving items from a designated one of the order storage bins.

The automated pickup system 200 comprises a user terminal, generally designated 220, that allows for a user to interact with (e.g., provide credentials for authenticating the user's identity or otherwise identifying the location of the user's order within the automated pickup system 200) the automated pickup system 200. Customer orders that have been fulfilled and are awaiting pickup or retrieval can be loaded into the automated pickup system 200 by employees of the retail store 101 (e.g., by such employees securely logging into the automated pickup system 200 via the user terminal 220).

In some embodiments, the automated pickup system 200 comprises a database that includes physical dimensions for each of the items offered for purchase by the retailer, such that the automated pickup system 200 can determine an approximate size for the storage bin 210 that is needed to accommodate all of the customer's items therein. Thus, in some embodiments, the storage bins 210 can have different sizes to accommodate therein different quantities and sizes of items in any given order. In some embodiments, the automated pickup system 200 comprises, for each storage bin 210, a tray, basket, or other suitable container (hereinafter, referred to as a “receptacle”). Thus, the items can be placed into a receptacle by an employee of the retailer during induction of the customer's order into the automated pickup system 200. In some embodiments, the automated pickup system 200 comprises an imaging system that is configured to detect the volume occupied by the items in a customer's order and to select a receptacle and storage bin 210 into which the customer's order should be deposited until retrieved based on the measured volume. Thus, orders can be stored more efficiently than if every storage bin 210 of the automated pickup system 200 was the same size.

When present at the automated pickup system 200, a customer can retrieve his/her order(s) by presenting authentication information (e.g., provided by the retailer) at the user terminal 220, after which the automated pickup system 200 transfers (e.g., using the transfer mechanism) the items associated with the customer's order from one or more of the order storage bins 210 to the pickup point 250, from which the customer can access the items that the customer ordered. The pickup point 250 is, in some embodiments, configured as an enclosed space that is selectively accessible, upon successful authentication of the customer at the user terminal 220, by a customer for retrieving the items ordered by the customer

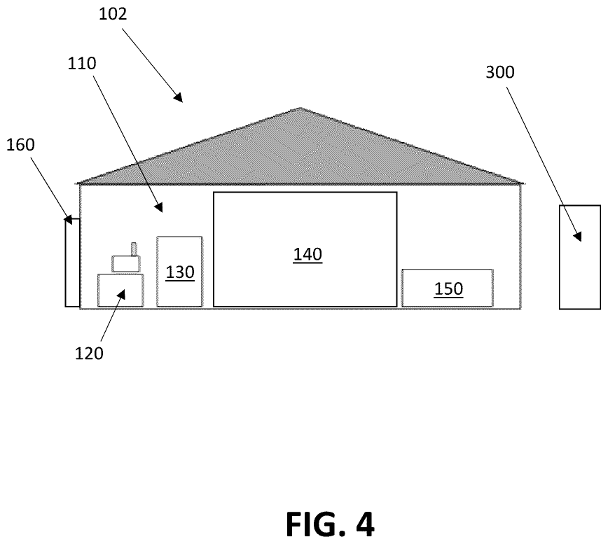

FIG. 4 shows another example embodiment of a retail store, generally designated 102, and an automated pickup system, generally designated 300. The retail store 102 has a main retail assortment 140 that is located a distance away from (e.g., so as to not be adjacent to) the retail store entrance, generally designated 160, to which the checkout lane area, generally designated 110, is adjacent. The checkout lane area 110 can comprise, for example, one or more (e.g., a plurality of) lines or queues in which customers wait until it is the customer's turn to proceed to the point of sale, generally designated 120, (e.g., a cash register or other commercial transaction terminal) to submit payment for the goods and/or services being purchased from the retailer. The checkout lane area 110 is thus positioned within the retail store 102 such that customers are directed to pass through the checkout lane area 110 when purchasing items (e.g., goods and/or services) at the point of sale 120 (e.g., a cash register). As the customers are being directed to pass through the checkout lane area 110, such customers are traditionally exposed to an impulse purchase area 130, which contains impulse purchase items and/or signage to encourage customers to make impulse purchases of specific items displayed to the consumers in the impulse purchase area 130. Additionally, as shown in FIG. 4, the retail store 102 also comprises a customer service desk 150, which is located apart (e.g., in a different section of the retail store 100) from the area of the retail store 100 in which the checkout lane area 110 is located.

The automated pickup system 300 is, as shown in FIG. 4, located separate from (e.g., physically segregated from, such as external to the retail store 102) the checkout lane area 110, the point of sale 120, and the impulse purchase area 130. The automated pickup system 300 can be, for example and without limitation, physically attached to the retail store 102 in which case the automated pickup system 300 is accessible to customers from inside and/or outside the retail store 102. In some embodiments, the automated pickup system 300 can be operated as a standalone structure, such as a kiosk, that can be deployed either inside or outside of the retail store 102. In a preferred embodiment, the automated pickup system 300 is in a location that is easy for customers to access. Thus, the automated pickup system 300 can be located, in various embodiments, outside the retail store 102, in a parking lot near the retail store 102, or even miles away from the retail store 102, such as in a location that is convenient to a designated community of customers of the retail store 102.

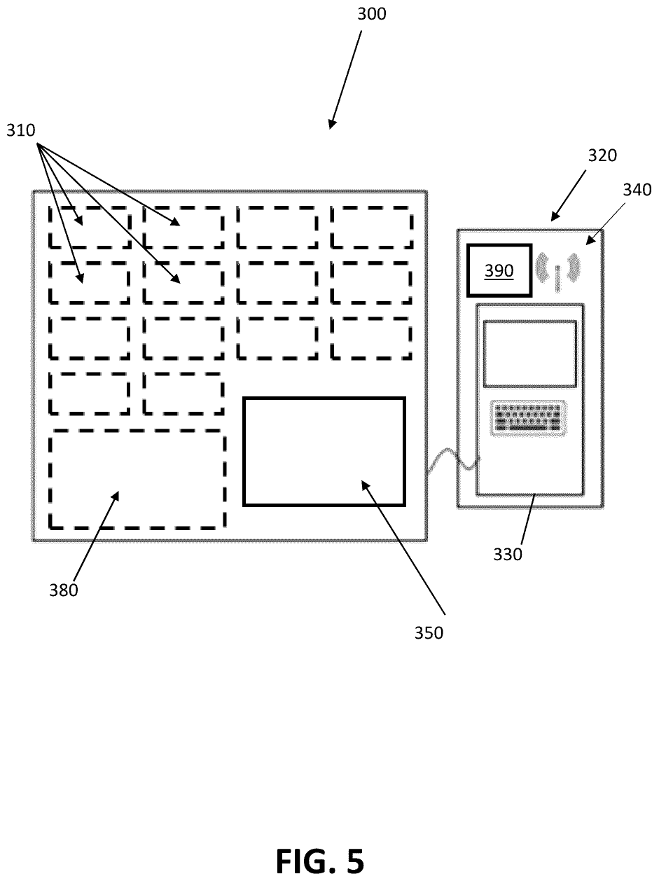

FIG. 5 shows an example embodiment of an automated pickup system, generally designated 300, which is designed to hold customer orders awaiting pickup or retrieval by the customer in one or more order storage bins, generally designated 310, which are internal to the automated pickup system 300, as well as impulse purchase items that are available for customers to purchase when retrieving their order(s) from the pickup point 350. The automated pickup system 300 also comprises a user terminal 320 that allows for a user to interact with (e.g., provide credentials for authenticating the user's identity or otherwise identifying the location of the user's order within the automated pickup system 300) the automated pickup system 300.

The impulse purchase items are stored in the impulse purchase item storage area 380, which is also internal to the automated pickup system 300. These impulse purchase items are items that are not already assigned to a customer order and are offered for sale directly to a customer at the automated pickup system 300 while the customer is retrieving his/her order from the automated pickup system 300. In some embodiments, the outer shell of the automated pickup system 300 can have a transparent (e.g., glass or plastic) window-type feature, through which the impulse purchase items in the impulse purchase item storage area 380 are visible by customers at the automated pickup system 300 (e.g., visible when a customer is positioned outside of the automated pickup system 300). In addition to or in lieu of the transparent window-type feature, impulse purchase signage 390 that is visible to the customer and is designed to entice customers to make impulse purchases of the impulse purchase items is provided on the user terminal 320 and/or on the exterior of the automated pickup system 300.

In some embodiments, the user terminal 320 is used to display images, videos, descriptions, advertisements, and the like (hereinafter, “promotional information”) of one or more of the impulse purchase items to a user, on a display of the user terminal 320. In some embodiments, the promotional information is in the form of one or more messages regarding the ability of the user to select any of the impulse purchase items for purchase, as an addition to the customer's existing order. The display of such promotional information can occur before, during, and/or after the customer's order has been delivered to the customer. In some embodiments, the automated pickup system 300 cross-references (e.g., in a database) the items in the customer's order with the impulse purchase items currently in stock at the automated pickup system 300, the impulse purchase item for which promotional information is to be presented to the customer at the user terminal 320 being for the impulse purchase item(s) that are most closely related to (e.g., most commonly ordered with) one or more items in the customer's order. Thus, the promotional information presented to the customer is selected based on relevance to the customer's order.

The automated pickup system 300 can thus be in the form of a housing that has a plurality of individually accessible lockers (e.g., order storage bins 310) provided therein that are accessible from outside of the housing to allow retrieval of items ordered by a customer from one or more of the individually accessible lockers. In the example embodiment shown, the order storage bins 310 are not directly accessible by a user from outside of the housing but are instead only accessible via a transfer mechanism (e.g., a series of conveyors, elevators, cranes, etc.) that is used for inputting items into a designated one of the order storage bins and/or retrieving items from a designated one of the order storage bins.

In some embodiments, the automated pickup system 300 comprises a database that includes physical dimensions for each of the items offered for purchase by the retailer, such that the automated pickup system 300 can determine an approximate size for the storage bin 310 that is needed to accommodate all of the customer's items therein. Thus, in some embodiments, the storage bins 310 can have different sizes to accommodate therein different quantities and sizes of items in any given order. In some embodiments, the automated pickup system 300 comprises, for each storage bin 310, a tray, basket, or other suitable container (hereinafter, referred to as a “receptacle”). Thus, the items can be placed into a receptacle by an employee of the retailer during induction of the customer's order into the automated pickup system 300. In some embodiments, the automated pickup system 300 comprises an imaging system that is configured to detect the volume occupied by the items in a customer's order and to select a receptacle and storage bin 310 into which the customer's order should be deposited until retrieved based on the measured volume. Thus, orders can be stored more efficiently than if every storage bin 310 of the automated pickup system 300 was the same size.

Customer orders that have been fulfilled and are awaiting pickup or retrieval can be loaded into the automated pickup system 300 by employees of the retail store 102 (e.g., by such employees securely logging into the automated pickup system 300 via the user terminal 320). Employees of the retail store 102 can also use the user terminal 320 to load impulse purchase items into the impulse purchase item storage area 380, to store impulse purchase items within the impulse purchase item storage area 380, and/or to remove impulse purchase items from the impulse purchase item storage area 380. When present at the automated pickup system 300, a customer can retrieve his/her order(s) by presenting authentication information (e.g., provided by the retailer) at the user terminal 320, after which the automated pickup system 300 transfers (e.g., using the transfer mechanism) the items associated with the customer's order from one or more of the order storage bins 310 to the pickup point 350, from which the customer can access the items that the customer ordered. The pickup point 350 is, in some embodiments, configured as an enclosed space that is selectively accessible, upon successful authentication of the customer at the user terminal 320, by a customer for retrieving the items ordered by the customer.

After the user terminal 320 presents (e.g., displays, as on a display screen thereof, which can be in the form of a touchscreen) the promotional information to the customer, if the user terminal 320 receives confirmation that the customer wants to add any of the impulse purchase items onto the customer's order, then the automated pickup system 300 is configured to dispense the impulse purchase item(s) selected by the customer directly to the customer, through the pickup point 350 along with the rest of the items in the customer's order or separately from the rest of the items in the customer's order. In some instances, the selected impulse purchase item(s) may be dispensed from another portal (e.g., a tray with a movable flap, such as in a conventional vending machine) that is separate from the pickup point 350 and is supplied with the selected impulse purchase item(s) directly from the impulse item storage area 380.

The promotional information may be in the form of one or more messages pertaining to the availability of impulse purchase items for sale, such messages may be selected based on the availability of the impulse purchase items within the automated pickup system 300, the relevance of any of the impulse purchase items to any of the items in the customer's order, etc. These one or more messages pertaining to the availability of impulse purchase items for sale may be presented to the customer while the customer's order is transferred from one of the order storage bins 310 to the pickup point 350. In some embodiments and since the customer will be looking at the pickup point 350 to know when his/her order is ready for retrieval from the pickup point 350, the promotional information pertaining to the availability of impulse purchase items for sale may be presented on a display device (e.g., a display screen, which can be a touchscreen) that is provided adjacent to (e.g., on an exterior surface of) the pickup point 350 and/or is adjacent to the pickup point 350. In some embodiments, the promotional information can be presented on such a display associated with the pickup point 350 and on a display of the user terminal 320. In some embodiments, the display on which the one or more messages pertaining to the availability of impulse purchase items for sale are displayed is larger than the pickup point 350 and the pickup point 350 is integrated within a portion of such display.

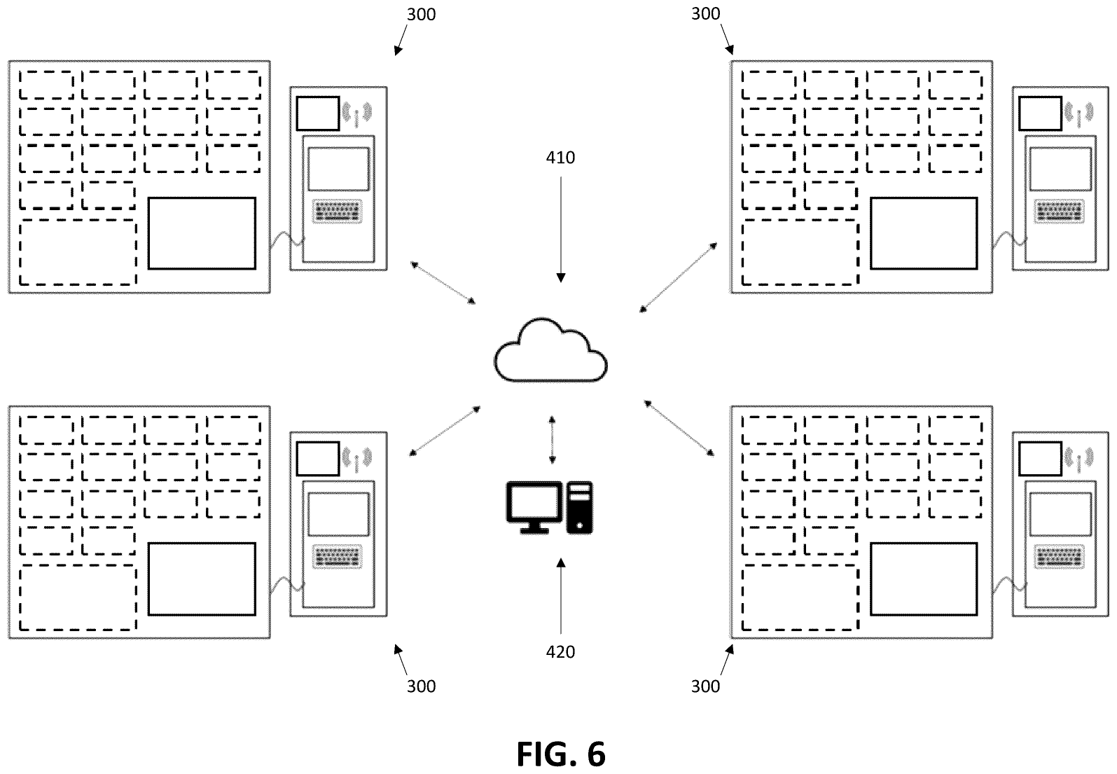

The automated pickup system 300 comprises, for controlling operation thereof and including the selection and display of promotional information by the automated pickup system 300, a controller 330. The controller 330 is used for one or more (e.g., all) of, for example, selecting an order storage bin 310 into which a customer's order is to be stored, authenticating the customer's order pickup credentials, sending a command to retrieve the customer's order from the designated storage bin 310, tracking that a customer's order has been removed from the pickup point 350, and the like. In some instances, the automated pickup system 300 comprises a transceiver 340 (e.g., a wired and/or wireless network adapter) that is configured to transmit and receive information (e.g., with a centralized controller 420, see FIG. 6) related to the customer's order, the inventory of items and/or orders (e.g., including impulse purchase items) within the automated pickup system 300, and the like.

In the example embodiment shown in FIG. 5, when the automated pickup system 300 receives confirmation and/or affirmation regarding the purchase of one or more of the impulse purchase items by the customer, the automated pickup system 300 transfers the selected impulse purchase item(s) from the impulse purchase item storage area 380 into the pickup point 350 for simultaneous retrieval, along with the customer's original order from the pickup point 350. Pickup point 350 is, in some embodiments, a single physical location or portal on the exterior of the automated pickup system 300, from which the entire order (e.g., the customer's original order, in addition to any impulse purchase items selected by the customer during order pickup) is retrieved. Pickup point 350 is, in some embodiments, a plurality of locations from which individual items of a customer's order are retrieved by the customer.

FIG. 6 shows an example embodiment of a plurality of the automated pickup systems 300 shown in FIG. 5. The automated pickup systems 300 shown in FIG. 6 are or, in the instance of alternative example embodiments described for the automated pickup system 300, can be the same as the automated pickup system 300 shown in FIG. 5 The plurality of automated pickup systems 300 are interconnected with each other via a network 410, such that each of the automated pickup systems 300 can be controlled in an efficient manner via a controller 420.

The automated pickup systems 300 shown in FIG. 6 are, as shown in FIG. 4, located separate from (e.g., physically segregated from, such as external to the retail store 102) the checkout lane area 110, the point of sale 120, and the impulse purchase area 130. The automated pickup systems 300 can be, for example and without limitation, physically attached to the retail store 102 in which case some or all of the automated pickup systems 300 are accessible to customers from inside and/or outside the retail store 102. In some embodiments, some or all of the automated pickup systems 300 can be operated as a standalone structure, such as a kiosk, that can be deployed either inside or outside of the retail store 102. In a preferred embodiment, some or all of the automated pickup systems 300 are in a location that is easy for customers to access. Thus, each of the automated pickup systems 300 can be located, for example, in one of the following: outside the retail store 102, in a parking lot near the retail store 102, and miles away from the retail store 102, such as in a location that is convenient to a designated community of customers of the retail store 102.

The automated pickup systems 300 are each designed to hold customer orders awaiting pickup or retrieval by the customer in one or more order storage bins, generally designated 310, which are internal to the automated pickup system 300, as well as impulse purchase items that are available for customers to purchase when retrieving their order(s) from the pickup point 350. The automated pickup system 300 also comprises a user terminal 320 that allows for a user to interact with (e.g., provide credentials for authenticating the user's identity or otherwise identifying the location of the user's order within the automated pickup system 300) the automated pickup system 300.

The automated pickup systems 300 each contain items that have been input therein (e.g., as a selection of items ordered by a customer) for a customer's order and also items that are not associated with any particular customer's order, but which are instead designated for being made available to customers for impulse purchases when the customer is retrieving his/her order from the automated pickup system 300. The automated pickup system is located as close as possible to an easily accessible location for the consumers who ordered items. In some embodiments, the automated pickup system 300 may be located remotely from a retail store (e.g., any source of the items ordered by the customer).

The impulse purchase items are stored in the impulse purchase item storage area 380, which is also internal to the automated pickup system 300. These impulse purchase items are items that are not already assigned to a customer order and are offered for sale directly to a customer at the automated pickup system 300 while the customer is retrieving his/her order from the automated pickup system 300. In some embodiments, the outer shell of the automated pickup system 300 can have a transparent (e.g., glass or plastic) window-type feature, through which the impulse purchase items in the impulse purchase item storage area 380 are visible by customers at the automated pickup system 300 (e.g., visible when a customer is positioned outside of the automated pickup system 300). In addition to or in lieu of the transparent window-type feature, impulse purchase signage 390 that is visible to the customer and is designed to entice customers to make impulse purchases of the impulse purchase items is provided on the user terminal 320 and/or on the exterior of the automated pickup system 300.

In some embodiments, the user terminal 320 of each of the user pickup systems 300 is used to display images, videos, descriptions, advertisements, and the like (hereinafter, “promotional information”) of one or more of the impulse purchase items to a user, on a display of the user terminal 320. In some embodiments, the promotional information is in the form of one or more messages regarding the ability of the user to select any of the impulse purchase items for purchase, as an addition to the customer's existing order. The display of such promotional information can occur before, during, and/or after the customer's order has been delivered to the customer. In some embodiments, the automated pickup systems 300 cross-reference (e.g., in a database, which can be stored in a memory of the automated pickup system 300 or in the controller 420) the items in the customer's order with the impulse purchase items currently in stock at the automated pickup system 300, the impulse purchase item for which promotional information is to be presented to the customer at the user terminal 320 being for the impulse purchase item(s) that are most closely related to (e.g., most commonly ordered with) one or more items in the customer's order. Thus, the promotional information presented to the customer is selected based on relevance to the customer's order.

The automated pickup systems 300 can thus be in the form of a housing that has a plurality of individually accessible lockers (e.g., order storage bins 310) provided therein that are accessible from outside of the housing to allow retrieval of items ordered by a customer from one or more of the individually accessible lockers. In the example embodiment shown, the order storage bins 310 are not directly accessible by a user from outside of the housing but are instead only accessible via a transfer mechanism (e.g., a series of conveyors, elevators, cranes, etc.) that is used for inputting items into a designated one of the order storage bins and/or retrieving items from a designated one of the order storage bins.

In some embodiments, the automated pickup systems 300 each comprise a database that includes physical dimensions for each of the items offered for purchase by the retailer, such that the automated pickup system 300 can determine an approximate size for the storage bin 310 that is needed to accommodate all of the customer's items therein. Thus, in some embodiments, the storage bins 310 can have different sizes to accommodate therein different quantities and sizes of items in any given order. In some embodiments, the automated pickup systems 300 comprise, for each storage bin 310, a tray, basket, or other suitable container (hereinafter, referred to as a “receptacle”). Thus, the items can be placed into a receptacle by an employee of the retailer during induction of the customer's order into the automated pickup system 300. In some embodiments, the automated pickup systems 300 comprise an imaging system that is configured to detect the volume occupied by the items in a customer's order and to select a receptacle and storage bin 310 into which the customer's order should be deposited until retrieved based on the measured volume. Thus, orders can be stored more efficiently than if every storage bin 310 in the same automated pickup system 300 was the same size.

In some embodiments, a retailer (e.g., a proprietor of retail store 102) that loads fulfilled customer orders into one or more of the order storage bins 310 in the automated pickup systems 300 can determine the contents of the impulse purchase items within the impulse purchase item storage area 380 and can control the quantity of such impulse purchase items (e.g., by replenishing the quantity of such impulse purchase items upon receipt of a notification of a low/no inventory of one or more of the impulse purchase items within the impulse purchase item storage area 380). For example, a retailer can make the impulse inventory 380 available for afternoon offers to include high value and high margin items such as meal kits, prepared meals, or other items commonly desirable around afternoon dinner hours. Similarly, during high outdoor temperature periods, the retailer can remove some of the impulse purchase items from the impulse purchase item storage area 380 and instead stock the impulse purchase item storage area 380 with, for example, chilled refreshing beverages commonly desirable on hot days. The quantity and type of impulse purchase items contained within the impulse purchase item storage area 380 is advantageously automatically determined upon loading of the impulse purchase items into the automated pickup system 300, whether at the user terminal 320 or via some other mechanism (e.g., barcode scanner within the impulse purchase item storage area 380, manual input, etc.).

In some embodiments, a retailer that loads fulfilled customer orders into the order storage bins 310 can authorize a vendor or other third-party to manage (e.g., load, removed, replenish, etc.) the impulse purchase items within the impulse purchase item storage area 380. In some such embodiments, the retailer or the vendor can control access to and availability of the impulse purchase items within the impulse purchase item storage area 380 and also of the impulse purchase signage 390.

In some embodiments, fulfilled customer orders contained within the order storage bins 310 are made available to customers at the pickup point 350 after customer validation at the user terminal 320. During customer validation at the user terminal 320, the retailer or a designated representative thereof can transmit one or more messages to the customer regarding the availability of one or more of the impulse purchase items to be made available to the customer contemporaneously with (e.g., simultaneously) the customer's original fulfilled order.

In some embodiments, the user terminal 320 is in the form of a mobile device (e.g., smartphone, tablet, etc.) that is owned and provided by the customer. In some such embodiments, the impulse purchase signage 390 can be presented to the customer on the customer's mobile device before the customer or the customer's representative, for example a delivery driver, arrives at automated pickup system 300. In some such embodiments, the impulse purchase signage 390 can be presented to the customer on the customer's mobile device while the customer is located at the automated pickup system 300 and before the customer is notified to retrieve the customer's order from the pickup point 350, so that customer's fulfilled order, as well as any impulse purchase items selected for purchase by the customer, can be retrieved simultaneously from the pickup point 350. The pickup point 350 can be, for example and without limitation, a drawer that pivots outwardly from the outer shell of the automated pickup system 300 and/or a door that opens to reveal a recessed volumetric region, or shelf, on which the customer's fulfilled order, along with any impulse purchase items selected for purchase by the customer, are placed by the automated pickup system 300 before the door is allowed to open.

Impulse purchase items selected for purchase by the customer can then automatically be made available to the customer as a component of their already fulfilled order.

In some embodiments, multiple automated pickup systems 300 can be connected via a network 410, such as is shown in FIG. 6, so that the quantities and types of impulse purchase items within the and the content of the impulse purchase signage 390 can be controlled by a centralized controller 420 to enable harmonized impulse purchases across a wide geographic area and customer base.

In some embodiments of the automated storage systems 300 shown in FIG. 6, customer orders that have been fulfilled and are awaiting pickup or retrieval can be loaded into the automated pickup systems 300 by employees of the retail store 102 (e.g., by such employees securely logging into the automated pickup system 300 via the user terminal 320). The location of the automated storage system 300 into which the customer's order is loaded can be selected based on a proximity of the customer's address to the location of one of the automated storage systems 300 or based on a selection provided by the customer during the order process. Employees of the retail store 102 can also use the user terminal 320 to load impulse purchase items into the impulse purchase item storage area 380, to store impulse purchase items within the impulse purchase item storage area 380, and/or to remove impulse purchase items from the impulse purchase item storage area 380. When present at a designated one the automated pickup system 300, a customer can retrieve his/her order(s) by presenting authentication information (e.g., provided by the retailer) at the user terminal 320, after which the automated pickup system 300 transfers (e.g., using the transfer mechanism) the items associated with the customer's order from one or more of the order storage bins 310 to the pickup point 350, from which the customer can access the items that the customer ordered. The pickup point 350 is, in some embodiments, configured as an enclosed space that is selectively accessible, upon successful authentication of the customer at the user terminal 320, by a customer for retrieving the items ordered by the customer.

After the user terminal 320 presents (e.g., displays, as on a display screen thereof, which can be in the form of a touchscreen) the promotional information to the customer, if the user terminal 320 receives confirmation that the customer wants to add any of the impulse purchase items onto the customer's order, then the automated pickup system 300 is configured to dispense the impulse purchase item(s) selected by the customer directly to the customer, through the pickup point 350 along with the rest of the items in the customer's order or separately from the rest of the items in the customer's order. In some instances, the selected impulse purchase item(s) may be dispensed from another portal (e.g., a tray with a movable flap, such as in a conventional vending machine) that is separate from the pickup point 350 and is supplied with the selected impulse purchase item(s) directly from the impulse item storage area 380.

The promotional information may be in the form of one or more messages pertaining to the availability of impulse purchase items for sale, such messages may be selected based on the availability of the impulse purchase items within the automated pickup system 300, the relevance of any of the impulse purchase items to any of the items in the customer's order, etc. These one or more messages pertaining to the availability of impulse purchase items for sale may be presented to the customer while the customer's order is transferred from one of the order storage bins 310 to the pickup point 350. In some embodiments and since the customer will be looking at the pickup point 350 to know when his/her order is ready for retrieval from the pickup point 350, the promotional information pertaining to the availability of impulse purchase items for sale may be presented on a display device (e.g., a display screen, which can be a touchscreen) that is provided adjacent to (e.g., on an exterior surface of) the pickup point 350 and/or is adjacent to the pickup point 350. In some embodiments, the promotional information can be presented on such a display associated with the pickup point 350 and on a display of the user terminal 320. In some embodiments, the display on which the one or more messages pertaining to the availability of impulse purchase items for sale are displayed is larger than the pickup point 350 and the pickup point 350 is integrated within a portion of such display.

When the automated pickup system 300 receives confirmation and/or affirmation regarding the purchase of one or more of the impulse purchase items by the customer, the automated pickup system 300 transfers the selected impulse purchase item(s) from the impulse purchase item storage area 380 into the pickup point 350 for simultaneous retrieval, along with the customer's original order from the pickup point 350. Pickup point 350 is, in some embodiments, a single physical location or portal on the exterior of the automated pickup system 300, from which the entire order (e.g., the customer's original order, in addition to any impulse purchase items selected by the customer during order pickup) is retrieved. Pickup point 350 is, in some embodiments, a plurality of locations from which individual items of a customer's order are retrieved by the customer.

Each of the automated pickup systems 300 comprises, for controlling operation thereof and including the selection and display of promotional information by the automated pickup system 300, a controller 330. The controller 330 is used for one or more (e.g., all) of, for example, selecting an order storage bin 310 into which a customer's order is to be stored, authenticating the customer's order pickup credentials, sending a command to retrieve the customer's order from the designated storage bin 310, tracking that a customer's order has been removed from the pickup point 350, and the like. In some instances, the automated pickup systems 300 comprise a transceiver 340 (e.g., a wired and/or wireless network adapter) that is configured to transmit and receive information with a centralized controller 420 related to the customer's order, the inventory of items and/or orders (e.g., including impulse purchase items) within the automated pickup system 300, and the like.

The present subject matter can be embodied in other forms without departure from the spirit and essential characteristics thereof. The embodiments described therefore are to be considered in all respects as illustrative and not restrictive. Although the present subject matter has been described in terms of certain preferred embodiments, other embodiments that are apparent to those of ordinary skill in the art are also within the scope of the present subject matter.

1. An automated order pickup system that enables impulse purchases of impulse purchase items during order pickup by a customer, the system comprising:
a housing;
a plurality of order storage bins contained within the housing;
a display; and
a user terminal comprising a controller configured to:
receive orders comprising one or more items that have been purchased or are designated for purchase by the customer, the order being designated for retrieval by the customer from the automated order pickup system;
assign each of the orders to at least one of the plurality of order storage bins;
authenticate a credential provided to the customer, the credential being unique to the customer and/or to the order to be received by the customer;
receive information regarding the impulse purchase items available for impulse purchase by the customer during retrieval of the order to be received by the customer; and
select promotional information for one or more of the impulse purchase items; and
wherein, when the customer selects to purchase any of the impulse purchase items, the order pickup system is configured to dispense the impulse purchase items selected for purchase to the customer, as well as the one or more items in the order to be received by the customer; and
wherein the promotional information is displayed to the customer on the display before, during, and/or after the customer receives the order.

2. The automated order pickup system of claim 1, wherein the housing comprises a single secure pickup point.

3. The automated order pickup system of claim 1, wherein the housing comprises multiple secure pickup points.

4. The automated order pickup system of claim 1, wherein the controller is configured to:
transmit information regarding types and/or quantities of the impulse purchase items stored in the order pickup system to a retailer or vendor; and
receive instructions from the retailer or vendor about which of the impulse purchase items the promotional information should be displayed to the customer.

5. The automated order pickup system of claim 1, wherein the promotional information regarding the availability of the impulse purchase items for purchase by the customer is selected by the controller based on time of day, day of week, day of year, and/or weather.

6. The automated order pickup system of claim 1, wherein:
the impulse purchase items include individual items, each of which can be purchased individually by the customer, separate from the one or more items in the customer's order; and/or
the impulse purchase items include groups of items, where each group of items can be purchased by the customer.

7. The automated order pickup system of claim 1, wherein the user terminal is a kiosk.

8. The automated order pickup system of claim 1, wherein the display is a mobile device provided by the customer.

9. The automated order pickup system of claim 1, wherein the system is configured to deliver any of the impulse purchase items selected for purchase by the customer simultaneously with the customer's order.

10. The automated order pickup system of claim 1, wherein the promotional information is selected based on which of the impulse purchase items is most often ordered along with any of the one or more items in the customer's order and/or which of the impulse purchase items is most often ordered along with any items in an order history of the customer.

11. A centralized pickup system comprising:
a plurality of the automated order pickup systems of claim 1;
a centralized controller; and
a network configured to connect the plurality of automated order pickup systems to the centralized controller;
wherein the centralized controller is configured to select the promotional information for one or more of the impulse purchase items across a designated geographic area across which the plurality of the automated order pickup systems is deployed and/or a customer base in a community designated for service by any of the plurality of the automated order pickup systems.

12. A method for enabling impulse purchases of impulse purchase items during automated pickup of one or more orders by a customer, the method comprising:
providing a plurality of the automated order pickup systems of claim 1;
providing a centralized controller;
connecting, using a network, the plurality of automated order pickup systems to the centralized controller system; and
using the centralized control system to select the promotional information for one or more of the impulse purchase items across a designated geographic area across which the plurality of the automated order pickup systems is deployed and/or a customer base in a community designated for service by any of the plurality of the automated order pickup systems.

13. A method for enabling impulse purchases of impulse purchase items during automated pickup of one or more orders by a customer, the method comprising:
providing a housing;
providing a plurality of order storage bins within the housing;
providing a display;
providing a user terminal comprising a controller;
receiving orders comprising one or more items that have been purchased or are designated for purchase by the customer, the order being designated for retrieval by the customer from the automated order pickup system;
assigning each of the orders to at least one of the plurality or order storage bins;
authenticating a credential provided to the customer, the credential being unique to the customer and/or to the order to be received by the customer;
receiving information regarding the impulse purchase items available for impulse purchase by the customer during retrieval of the order to be received by the customer;
selecting promotional information for one or more of the impulse purchase items;
displaying the promotional information to the customer on the display; and
dispensing, when the customer selects to purchase any of the impulse purchase items, the impulse purchase items selected for purchase to the customer, as well as the one or more items in the order to be received by the customer;
wherein the promotional information is displayed to the customer before, during, and/or after the customer receives the order.

14. The method of claim 13, wherein the housing comprises a single secure pickup point.

15. The method of claim 13, wherein the housing comprises multiple secure pickup points.

16. The method of claim 13, comprising:
transmitting information regarding types and/or quantities of the impulse purchase items stored in the order pickup system to a retailer or vendor; and
receiving instructions from the retailer or vendor about which of the impulse purchase items the promotional information should be displayed to the customer.

17. The method of claim 13, wherein the promotional information regarding the availability of the impulse purchase items for purchase by the customer is selected based on time of day, day of week, day of year, and/or weather.

18. The method of claim 13, wherein:
the impulse purchase items include individual items, each of which can be purchased individually by the customer, separate from the one or more items in the customer's order; and/or the impulse purchase items include groups of items, where each group of items can be purchased by the customer.

19. The method of claim 13, wherein the user terminal is a kiosk. The method of claim 13, wherein the user terminal is a mobile device provided by the customer.

21. The method of claim 13, wherein the impulse purchase items selected for purchase by the customer are delivered to the customer simultaneously with the customer's order.

22. The method of claim 13, wherein the promotional information is selected based on which of the impulse purchase items is most often ordered along with any of the one or more items in the customer's order and/or which of the impulse purchase items is most often ordered along with any items in an order history of the customer.
